(19) United States
(12) Patent Application Publication
(10) Pub. No.: US 2004/0108808 A1
(43) Pub. Date: Jun. 10, 2004

(54) Display apparatus, and display apparatus manufacturing method and apparatus

(75) Inventors: Minoru Kumagai, Tokyo (JP); Tomoyuki Shirasaki, Tokyo (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Casio Computer Co., Ltd., Tokyo (JP)

(21) Appl. No.: 10/716,885

(22) Filed: Nov. 18, 2003

(30) Foreign Application Priority Data
Nov. 19, 2002 (JP) 2002-335237

(51) Int. Cl. H01J 63/04

(52) U.S. Cl. 313/505

(57) ABSTRACT

A method of manufacturing a display apparatus including an optical element having an optical material layer between a first electrode and a second electrode which are formed on a substrate, includes an aligning step of making the substrate oppose a plate which has a wettability changeable layer and to which a droplet of an optical material containing liquid sticks in accordance with a pattern based on a difference in wettability. The substrate and the plate are aligned with each other, and the droplet is bring into contact with the substrate to transfer the droplet to the substrate side, thereby forming the optical material layer.

### CROSS-REFERENCE TO RELATED APPLICATIONS

This application is based upon and claims the benefit of priority from the prior Japanese Patent Application No. 2002-335237, filed Nov. 19, 2002, the entire contents of which are incorporated herein by reference.

### BACKGROUND OF THE INVENTION

1. Field of the Invention

The present invention relates to a display apparatus having optical elements formed on a substrate, and a display apparatus manufacturing method and apparatus.

2. Description of the Related Art

An organic EL element has a multilayered structure in which an anode, an EL layer made of an organic compound, and a cathode are stacked in this order. When a positive bias voltage is applied between the anode and the cathode, the EL layer emits light. A plurality of such organic EL elements each serving as a sub pixel that emits red, green, or blue light are arrayed in a matrix on a substrate, thereby implementing an organic EL display panel that displays an image.

In an active matrix driving organic EL display panel, one of the anode and cathode can be formed as a common electrode common to all sub pixels. At least the other electrode and EL layer must be patterned for each sub pixel. A conventional semiconductor device manufacturing technique can be applied as a method of patterning an anode or cathode for each sub pixel. That is, an anode or cathode can be patterned for each sub pixel by appropriately executing a film formation step using PVD or CVD, a mask step using photo-lithography, and a thin film shape process step using etching.

Jpn. pat. Appln. KOKAI Publication No. 10-12377 and 2000-353594 propose a technique for patterning an EL layer for each sub pixel by using the inkjet technology. In this technique, a material for an EL layer is dissolved in an organic solvent to prepare an organic solution. A droplet of the solution is discharged from a nozzle for each sub pixel, thereby patterning the EL layer for each sub pixel.

In this technique for patterning the EL layer by using the inkjet method, the solvent in which the organic material for the EL layer is dissolved may evaporate at the tip portion of the nozzle that discharges the solution. Since the nozzle may then clog, a defective sub pixel without any EL layer may be formed, or the EL layer thickness in a sub pixel may become nonuniform.

When the EL layer should be patterned by the inkjet method, the EL solution must be discharged while aligning the nozzle to each sub pixel position and sequentially scanning the sub pixels. Hence, the time taken to pattern all EL layers in the plane is long. To pattern all EL layers in the plane in a short time, the inkjet apparatus must have a plurality of nozzles so that the organic solution is applied simultaneously from them. In this case, the plurality of nozzles must be arrayed in a single plane in the inkjet apparatus. To provide an organic EL display panel which attains a high resolution by precisely arraying sub pixels, the plurality of nozzles must also be precisely arrayed. The array must be finely designed in accordance with the distance between adjacent sub pixels, resulting in a difficulty. Hence, with film formation using only the inkjet method, it is difficult to precisely pattern the EL layer in a short time.

### BRIEF SUMMARY OF THE INVENTION

It is an object of the present invention to provide a display apparatus obtained by efficiently executing precise pixel patterning, and a display apparatus manufacturing method and apparatus.

In order to achieve the above object, according to a first aspect of the present invention, there is provided a display apparatus comprising:

a substrate;

a first electrode and a second electrode which are formed on the substrate; and

an optical material layer which is located between the first electrode and the second electrode and formed by bringing a droplet of an optical material containing liquid, that sticks to a predetermined position of a surface of a plate in accordance with a pattern based on a difference in wettability, into contact with the substrate and transferring the droplet to the substrate side.

Since the droplet is transferred, the optical material layer can quickly be formed, and a structure suitable for mass production can be obtained. When a partition is formed, the droplet can be surrounded by the partition. Hence, the optical material layer having a predetermined shape can be accurately patterned. Especially when a partition having liquid repellency is used, the droplet can be suppressed from flowing to pixels other than the desired pixel.

According to a second aspect of the present invention, there is provided a method of manufacturing a display apparatus including an optical element having an optical material layer between a first electrode and a second electrode which are formed on a substrate, comprising:

an aligning step of making the substrate oppose a plate which has a wettability changeable layer and to which a droplet of an optical material containing liquid sticks in accordance with a pattern based on a difference in wettability, and of aligning the substrate and the plate; and

a transfer step of bringing the droplet into contact with the substrate to transfer the droplet to the substrate side, thereby forming the optical material layer.

According to this method, since films of the optical material containing liquid can be formed simultaneously for a plurality of pixels, the productivity is higher than that of the inkjet method which applies the optical material containing liquid to each pixel. The liquid repellent portion of the wettability changeable layer of the pattern repels the optical material containing liquid. Most of the optical material containing liquid collects at a desired pattern portion. Since the amount of the optical material containing liquid can be a minimum necessary amount, the cost can be reduced.

According to a third aspect of the present invention, there is provided a display apparatus manufacturing apparatus for manufacturing a display apparatus including an optical element having an optical material layer between a first electrode and a second electrode which are formed on a substrate, comprising:

moving means, having a plate having a wettability changeable layer with a pattern based on a difference in wettability to an optical material containing liquid, for bringing a droplet sticking to the wettability changeable layer into contact with the substrate.

According to the present invention, a droplet can be patterned at a desired position of a plate by changing the wettability by irradiating the plate with active rays. Hence, the droplet of the optical material containing liquid can be quickly transferred to the substrate side as compared to the inkjet method.

In this specification, an “optical material containing liquid” indicates a liquid containing an organic compound that forms the optical material layer or a precursor thereof. The liquid may be a solution prepared by dissolving an organic compound or a precursor thereof. Alternatively, the liquid may be a dispersion prepared by dispersing an organic compound or a precursor thereof. The liquid may partially contain an inorganic substance. “Active rays” indicate rays that excite a photocatalyst, including visible rays, UV rays, electron beam, and infrared rays. Examples of a “photocatalyst” are titanium oxide, zinc oxide, tin oxide, strontium titanate, tungsten oxide, bismuth oxide, and iron oxide.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing an organic EL display panel according to the first embodiment of the present invention;

FIG. 2 is a sectional view of the organic EL display panel shown in FIG. 1;

FIGS. 3A to 3D are sectional views showing steps in manufacturing the organic EL display panel shown in FIG. 1;

FIG. 4 is a sectional view showing a step in manufacturing a plate to be used to manufacture the organic EL display panel shown in FIG. 1;

FIGS. 5A to 5C are sectional views showing steps in manufacturing the organic EL display panel shown in FIG. 1;

FIGS. 6A to 6C are sectional views showing steps in manufacturing the organic EL display panel shown in FIG. 1;

FIGS. 7A to 7C are sectional views showing steps in manufacturing the organic EL display panel shown in FIG. 1 as a modification to the first embodiment;

FIG. 8 is a sectional view showing an organic EL display panel according to the second embodiment of the present invention;

FIGS. 9A to 9C are sectional views showing steps in manufacturing the organic EL display panel shown in FIG. 8;

FIGS. 10A and 10B are sectional views showing steps in manufacturing the organic EL display panel shown in FIG. 8;

FIGS. 11A to 11C are sectional views showing steps in manufacturing the organic EL display panel shown in FIG. 8;

FIG. 12 is a sectional view showing an organic EL display panel according to the third embodiment of the present invention;

FIGS. 13A to 13C are sectional views showing steps in manufacturing the organic EL display panel shown in FIG. 12;

FIGS. 14A and 14B are sectional views showing steps in manufacturing the organic EL display panel shown in FIG. 12; and

FIGS. 15A to 15C are sectional views showing steps in manufacturing the organic EL display panel shown in FIG. 12.

### DETAILED DESCRIPTION OF THE INVENTION

Detailed embodiments of the present invention will be described below with reference to the accompanying drawing. However, the scope of the invention is not limited to the illustrated examples. In the following description, “when viewed from the upper side” means “when viewed from a direction perpendicular to the planar direction of a transparent substrate 12 (to be described later)”.

[First Embodiment]

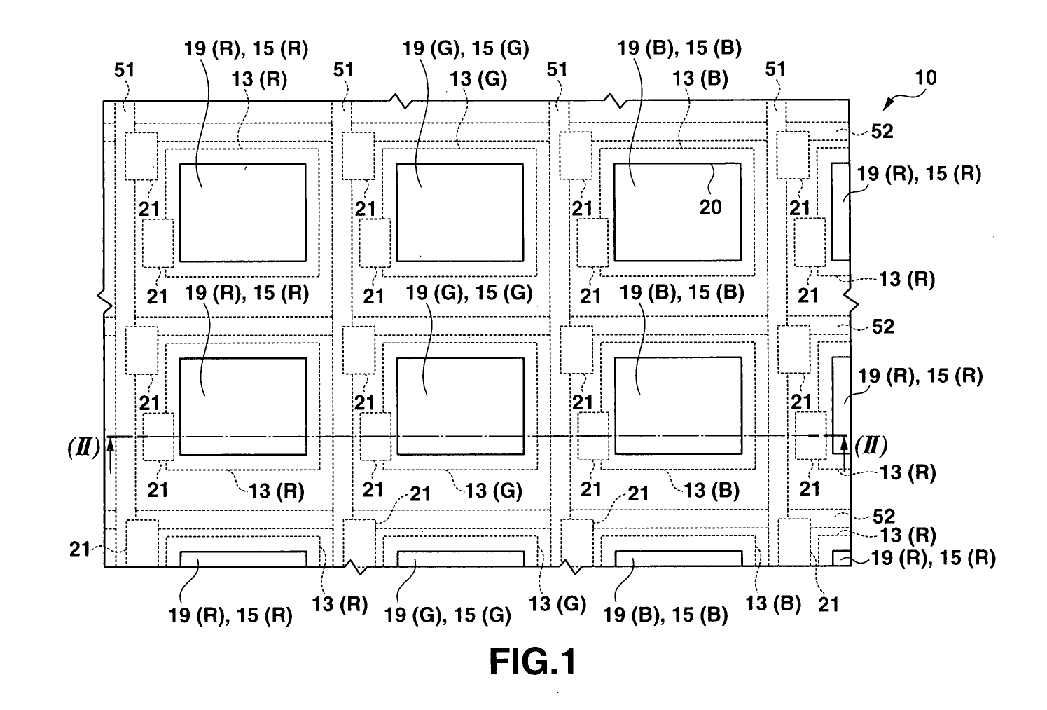

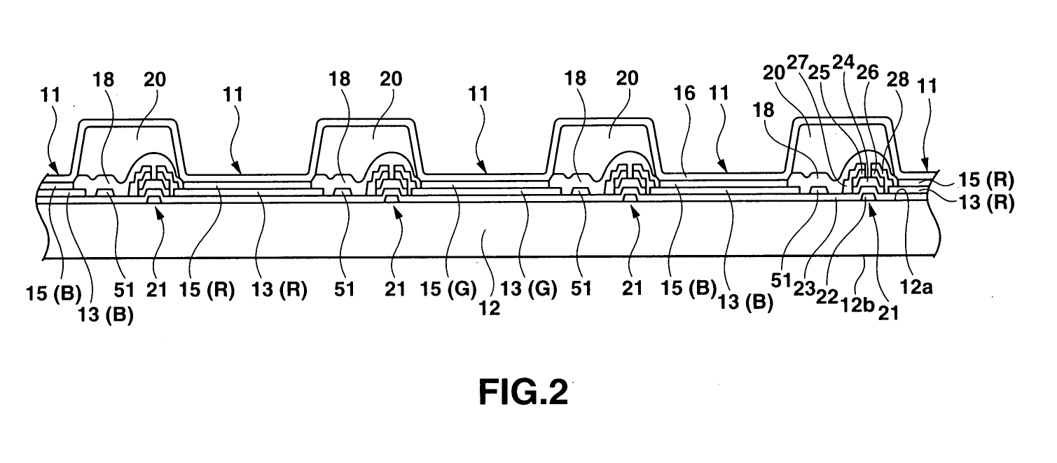

FIG. 1 is a plan view of an organic EL display panel 10 serving as a display apparatus. FIG. 2 is a sectional view taken along a line (II)-(II) in FIG. 1.

In the organic EL display panel 10, red, green, and blue sub pixels are arrayed in a matrix when viewed from the upper side. The organic EL display panel 10 executes matrix display by an active matrix driving method. More specifically, in the organic EL display panel 10, each sub pixel is constituted by one organic EL element 11 and one pixel circuit that drives the organic EL element 11. A signal is input from a peripheral driver (not shown) to the pixel circuit through a signal line 51 and a scanning line 52. The pixel circuit turns on/off a current flowing to the organic EL element 11 in accordance with the signal. Alternatively, the pixel circuit holds the current value to keep a predetermined luminance of the organic EL element 11 during its light emission period. The pixel circuit is formed from at least one thin-film transistor per sub pixel. A capacitor and the like are sometimes added as needed. In this embodiment, the pixel circuit is formed from two transistors 21. Three sub pixels of red, green, and blue are continuously arrayed to form one pixel.

The organic EL display panel 10 has a flat transparent substrate 12. The plurality of scanning lines 52 run in the horizontal direction on one surface 12a of the transparent substrate 12. The scanning lines 52 are arrayed parallel to each other almost at an equal interval when viewed from the upper side. The scanning lines 52 have electrical conductivity. The scanning lines 52 are covered with a gate insulating film 23 formed on the entire surface 12a of the transparent substrate 12. The plurality of signal lines 51 run in the vertical direction on the gate insulating film 23. The signal lines 51 are perpendicular to the scanning lines 52 when viewed from the upper side. The signal lines 51 are also arrayed parallel to each other almost at an equal interval when viewed from the upper side.

The plurality of transistors 21 are formed on the surface 12a of the transparent substrate 12. Each transistor 21 is formed from a gate electrode 22, gate insulating film 23, semiconductor film 24, impurity-doped semiconductor films 25 and 26, drain electrode 27, and source electrode 28. These components are stacked to form an MOS field effect transistor. The gate insulating film 23 is formed on the entire surface of the transparent substrate 12. The gate insulating film 23 is common to all the transistors 21.

The transistors 21 are covered with a protective insulating film 18. The protective insulating film 18 is formed into a mesh pattern along the signal lines 51 and scanning lines 52 when viewed from the upper side. Accordingly, a plurality of surrounded regions 19 surrounded by the protective insulating film 18 are formed as if they were arrayed in a matrix on the transparent substrate 12. The protective insulating film 18 is made of an inorganic silicide such as silicon oxide (SiO₂) or silicon nitride (SiN).

A partition 20 is formed on the protective insulating film 18. The partition 20 is also formed into a mesh pattern when viewed from the upper side, like the protective insulating film 18. The width of the partition 20 increases toward the transparent substrate 12. The partition 20 has insulating properties. The partition 20 is made of an organic compound such as a photosensitive resin like polyimide resin, acrylic resin, or novolac resin. A film (e.g., a fluoroplastic film) with a “liquid repellency” may be formed on the surface of the partition 20. The surface layer of the partition 20 may have liquid repellency. The “liquid repellency” is a surface property in which the surface has a contact angle of more than 40° with an “organic compound containing liquid (liquid which contains an organic compound)”, i.e., an optical material containing liquid. In other words, the liquid repellency is a surface property in which the surface repels the organic compound containing liquid. The “organic compound containing liquid” is a liquid containing an organic compound as the optical material that forms an EL layer 15 (15(R), 15(G), 15(B)) which is to be described later or its precursor. The organic compound containing liquid may be a solution prepared by dissolving, as a solute, an organic compound that forms the EL layer 15 or its precursor in a solvent. The organic compound containing liquid may be a dispersion prepared by dispersing an organic compound that forms the EL layer 15 or its precursor in a liquid. The liquid repellency of the partition 20 will be described later in detail in the section “Lyophilic Process and Liquid Repellent Process”.

The organic EL element 11 as an optical element will be described next. The organic EL element 10 has a multilayered structure in which an anode 13 (13(R), 13(G), 13(B)), the EL layer 15, and a cathode 16 are stacked in this order from the side of the transparent substrate 12. The anode 13 has a transparency to visible light and electrical conductivity. The anode 13 is made of a material having a relatively high work function. The anode 13 is made of, e.g., indium oxide, zinc oxide, or tin oxide or a mixture containing at least one of them (e.g., indium tin oxide (ITO) or indium zinc oxide).

The anode or anode section 13 is formed in each of regions surrounded by the signal lines 51 and scanning lines 52 when viewed from the upper side. The plurality of anode sections 13 are arrayed in a matrix on the gate insulating film 23 at an interval.

Each anode section 13 corresponds to one surrounded region 19 when viewed from the upper side. The area of the surrounded region 19 is smaller than that of the anode 13. The surrounded region 19 is arranged in the anode 13. The outer peripheral portion of the anode 13 partially overlaps the protective insulating film 18 and partition 20. In this example, the anode 13 is connected to the source electrode 28 of the transistor 21. Alternately, the anode 13 may be connected to another transistor or capacitor depending on the circuit arrangement of the pixel circuit. A film with a “lyophilic effect” may be formed on the surface of the anode 13. The surface layer of the anode 13 may have a lyophilic effect. The “lyophilic effect” indicates a surface property in which the surface has a contact angle of 400 or less with an organic compound containing liquid, and the organic compound containing liquid is hardly repelled. That is, the lyophilic effect means a surface wets well with the organic compound containing liquid. The lyophilic effect of the anode 13 will be described later in detail in the section “Lyophilic Process and Liquid Repellent Process”.

The EL layer 15 is formed on each anode section 13. The EL layers 15 are arrayed in a matrix when viewed from the upper side and arranged in corresponding surrounded regions 19.

The EL layer 15 is an optical material layer made of a light-emitting material as an organic compound. The EL layer 15 recombines holes injected from the anode 13 and electrons injected from the cathode 16 to generate excitons and emits red, green, or blue light. For example, an EL layer 15 that emits red light, an EL layer 15 that emits green light, and an EL layer 15 that emits blue light are arrayed in the horizontal direction in this order. The color tone of one pixel is defined by the three color EL layers 15. Throughout the drawings, (R) is added to the EL layer 15 that emits red light. (G) is added to the EL layer 15 that emits green light. (B) is added to the EL layer 15 that emits blue light. (R), (G), or (B) is also added to the anode 13 and surrounded region 19 corresponding to each color.

An electron transport substance may be mixed into the EL layer 15, as needed. A hole transport substance may be mixed into the EL layer 15, as needed. Both an electron transport substance and a hole transport substance may be mixed into the EL layer 15, as needed.

Each EL layer 15 may have a three-layered structure including a hole transport layer, a light-emitting layer of narrow sense, and an electron transport layer sequentially from the anode 13. Alternately, each EL layer 15 may have a two-layered structure including a hole transport layer and a light-emitting layer of narrow sense sequentially from the anode 13. Each EL layer 15 may have a single-layered structure including a light-emitting layer of narrow sense. Alternatively, each EL layer 15 may have a multilayered structure in which an electron or hole injection layer is inserted between appropriate layers in one of the above layer structures. The EL layers 15 are formed by waterless lithography, as will be described later. The hole transport layer, light-emitting layer of narrow sense, and electron transport layer are also layers made of organic compounds. That is, they are optical material layers.

The cathode 16 is formed continuously on the entire one side of the transparent substrate 12 to cover all the EL layers 15 and the partition 20. The cathode 16 opposes the anode 13 in each surrounded region 19. The cathode 16 contains at least a material having a low work function in the surface that is in contact with the EL layers 15. More specifically, the cathode 16 is made of a simple substance selected from magnesium, calcium, lithium, barium, and a rare earth, or an alloy containing at least one of these simple substances. The cathode 16 may have a multilayered structure. For example, the cathode 16 may have a multilayered structure in which the surface of a film made of the above-described material with a low work function is covered with a material such as aluminum or chromium that has a high work function and low resistivity. The cathode 16 preferably has a light shielding effect with respect to visible light. The cathode 16 more preferably has a high reflectivity to visible light emitted from the EL layer 15. That is, since the cathode 16 acts as a mirror surface that reflects visible light, the light utilization efficiency can be increased.

As described above, the cathode 16 is a continuous layer common to all sub pixels. The anode 13 and EL layer 15 are separately formed for each sub pixel.

A method of manufacturing the organic EL display panel 10 will be described next.

The manufacturing method of the organic EL display panel 10 comprises the following steps.

(i) Driving Substrate Manufacturing Step: The transistors 21, anodes 13, and partition 20 are sequentially formed on the transparent substrate 12.

(ii) Print Step: The EL layers 15 are formed for each color by using a plate of a corresponding color. More specifically, an organic compound-containing liquid containing an organic compound that emits red light is applied to a red plate. The organic compound containing liquid applied to the red plate is transferred to the transparent substrate 12. With this process, the red EL layers 15(R) are formed on the red anodes 13(R). In a similar way, the green EL layers 15(G) and blue EL layers 15(B) are also sequentially formed by using green and blue plates.

(iii) Electrode Formation Step: The cathode 16 is formed.

These steps will be described below in detail.

First, a “plate making step” is executed as preparation for (i) driving substrate manufacturing step. In the plate making step, a master is prepared for each of red, green, and blue. A red plate, green plate, and blue plate are made from these masters. The red plate is used to pattern the red EL layers 15(R). The green plate is used to pattern the green EL layers 15(G). The blue plate is used to pattern the blue EL layers 15(B).

There are two plate making methods. Both the plate making methods use photocatalytic reaction and can be applied to all the red, green, and blue plates.

The first plate making method will be described.

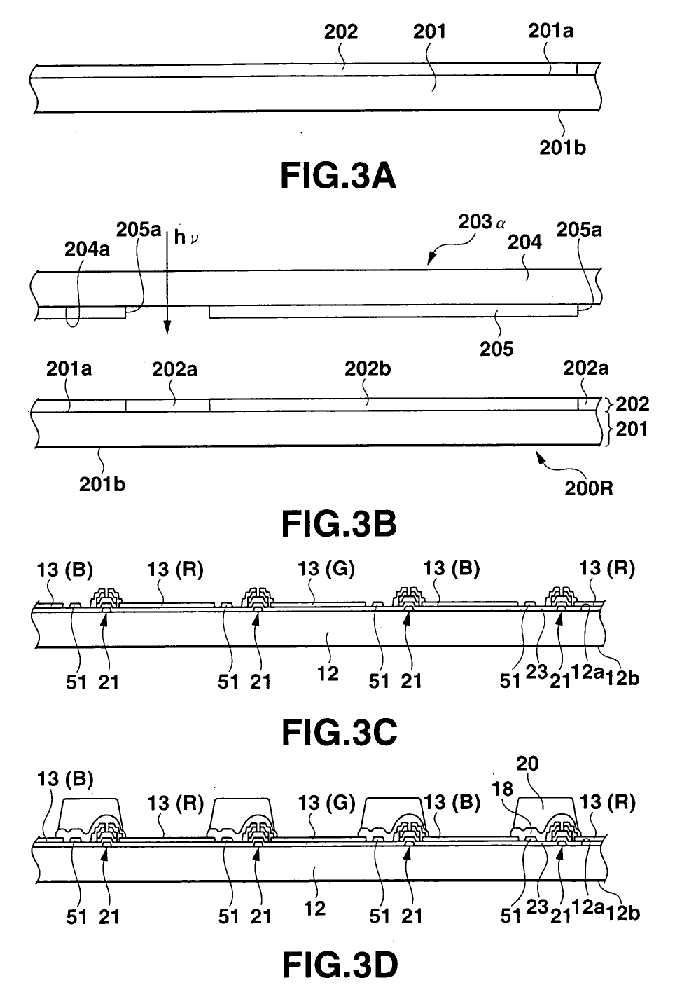

First, as shown in FIG. 3A, a wettability changeable layer 202 is formed on a surface 201a of a substrate 201 as a flat base material. This is the master for a plate.

The wettability changeable layer 202 changes its wettability when irradiated with active rays hν. The wettability changeable layer 202 contains a photocatalyst which causes a change in wettability. As the active rays hν, rays in any wave range that excites the photocatalyst can be used, including visible rays, UV rays, and infrared rays.

Examples of the photocatalytic material used for the wettability changeable layer 202 are metal oxides such as titanium oxide (TiO₂), zinc oxide (ZnO), tin oxide (SnO₂), strontium titanate (SrTiO₃), tungsten oxide (WO₃), bismuth oxide (Bi₂O₃), and iron oxide (Fe₂O₃), which are known as optical semiconductors. Especially, titanium oxide is preferably used. Either anatase-type titanium oxide or rutile-type titanium oxide can be used. Anatase-type titanium oxide is more preferably used because the excitation wavelength is 380 nm or less. The amount of the photocatalyst in the photocatalyst containing layer is preferably 5 to 60 wt %, and more preferably, 20 to 40 wt %.

The binder that can be used in the wettability changeable layer 202 preferably has a high binding energy so that the principal skeleton does not decompose upon photoexcitation of the photocatalyst. Examples of such a material are (A) organopolysiloxane that exhibits a high strength by hydrolyzing and polycondensing chlorosilane or alkoxysilane by sol-gel reaction and (B) organopolysiloxane crosslinked to reactive silicone that has a high water repellency or oil repellency.

In (A), the main component can be one or two or more hydrolytic condensates or hydrolytic co-condensates of a silicide, which are represented by a general formula R³ₙSiR⁴₄₋ₙ (n=1 to 3). In this general formula, R³ can be, e.g., an alkyl group, fluoroalkyl group, vinyl group, amino group, or epoxy group. R⁴ can be, e.g., a halogen or a functional group, methoxyl group, ethoxyl group, or acetyl group containing a halogen. Polysiloxane containing a fluoroalkyl group can particularly preferably be used as a binder. More specifically, one or two or more hydrolytic condensates or hydrolytic co-condensates of fluoroalkylsilane can be used. Alternatively, a generally known fluorine-based silane coupling agent may be used. Examples of a fluoroalkyl group are functional groups represented by

—(CH₂)ₐ(CF₂)_{b}CF₃ (1)

—(CH₂)_{c}(CF₂)_{d}CF(CF₃)₂ (2)

wherein a, b, c, and d are integers (a, b, c, d≧0).

An example of the reactive silicone of (B) is a compound having a skeleton represented by

—(Si(R¹)(R²)O)ₙ— (3)

wherein n is an integer (n≧2), and R¹ and R² can be a substituted or non-substituted alkyl, alkenyl, aryl, or cyanoalkyl group with a carbon number 1 to 10. Preferably, 40 mol % or less of the entire compound can be vinyl, phenyl, or phenyl halide. At least one of R¹ and R² is preferably a methyl group because the surface energy is minimum. More preferably, the content of the methyl group is 60 mol % or more, and at least one reactive group such as a hydroxyl group is present in the molecular chain of the chain terminal or side chain.

In addition to organopolysiloxane described above, a stable organo silicide such as dimethyl polysiloxane that causes no crosslinking reaction may be mixed into the binder.

The wettability changeable layer 202 can be formed by, e.g., applying a coating liquid containing a photocatalyst to the base material by spray coating, dip coating, roll coating, or bead coating. When a coating liquid containing a photocatalyst is to be used, a solvent that can be used for the coating liquid is not particularly limited. An example of the solvent is an alcohol-based organic solvent such as ethanol or isopropanol.

An example of the method of forming the wettability changeable layer 202 will be described in detail.

The substrate 201 is cleaned by pure water. A coating liquid (to be referred to as a silazane-based solution hereinafter) prepared by dissolving a silazane compound having a fluoroalkyl group is applied to the surface 201a of the substrate 201 by dip coating. A photocatalyst is dispersed in this silazane-based solution.

The “silazane compound having a fluoroalkyl group” has an Si—N—Si bond. The fluoroalkyl group is bonded to N and/or Si. An example is a monomer, oligomer, or polymer represented by

RfSi(NH)_{3/2} (4)

wherein Rf is a fluoroalkyl group.

An example of the solvent for the silazane-based solution is a fluorine-based solvent.

As the silazane compound, a silazane oligomer (KP-801M available from Shin-Etsu Chemical Co., Ltd.) represented by general formula (5) and chemical structure formula (6) is used. In the above-described dip coating step, a silazane-based solution (concentration: 3%) prepared by dissolving the silazane oligomer as a solute in an m-xylene hexafluoride solvent is applied to the substrate 201 by dip coating.

C₈F₁₇C₂H₄Si(NH)_{3/2} (5)

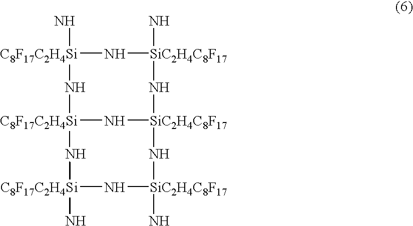

Next, an inert gas such as nitrogen gas or argon gas is blown to the substrate 201 to evaporate the solvent of the silazane-based solution. The silazane compound is deposited on the surface 201a of the substrate 201. The solvent may be evaporated by heating.

When the substrate 201 is left to stand for 10 to 30 min, the silazane compound hydrolyzes in the presence of water in the atmosphere, and bonds and polymerizes to the surface of the substrate 201. The wettability changeable layer 202 which contains, as a binder, a condensate having a fluoroalkyl group bonded to a main chain made of silicon and oxygen is formed on the substrate 201. The condensate contained in the wettability changeable layer 202 is represented by

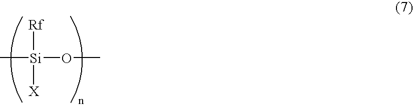

wherein Rf is a fluoroalkyl group having liquid repellency, as described above, and X is the atom of the substrate 201 or an atom chemically adsorbed in the surface of the substrate 201. When the silazane compound is a silazane oligomer represented by general formula (5), Rf is C₈F₁₇C₂H₄. The binder of the wettability changeable layer 202 is a condensate whose side chain contains a functional group containing fluorine. Hence, the wettability changeable layer 202 has a low wettability to an organic compound containing liquid and exhibits liquid repellency. The formed wettability changeable layer 202 contains a photocatalyst.

As shown in FIG. 3B, the wettability changeable layer 202 is partially irradiated with the active rays hν by using a photomask substrate 203α. A red plate 200R is thus completed.

The photomask substrate 203α has a flat transparent substrate 204 that passes the active rays hν. A mesh-like mask 205 that hardly passes the active rays hν is formed on a surface 204a of the transparent substrate 204. Since the mask 205 has a mesh pattern, a number of opening portions 205a are formed in the mask 205. The array pattern of the opening portions 205a when viewed from the upper side is the same as the array pattern of the surrounded regions 19(R) corresponding to the pixels that emit red light.

The photomask substrate 203α having the above structure is made to oppose the wettability changeable layer 202. The wettability changeable layer 202 is irradiated with the active rays hν through the photomask substrate 203α. The mask 205 of the photomask substrate 203α shields the active rays hν while the opening portions 205a pass the active rays hν. In this way, the active rays hν become incident on the wettability changeable layer 202. In the lyophilic region 202a where the active rays hν are incident, since the active rays hν become incident on the photocatalyst (e.g., titanium oxide), active oxygen species (e.g., ·OH) are generated. The active oxygen species desorb the functional group (e.g., Rf) that exhibits liquid repellency and substitutes it with a functional group (e.g., —OH) that exhibits a lyophilic effect. For this reason, in the lyophilic region 202a where the active rays hν are incident, the wettability increases, and a lyophilic effect is obtained. Accordingly, a pattern based on a difference in wettability, i.e., a pattern having the lyophilic region 202a and a liquid repellent region 202b is formed in the wettability changeable layer 202.

The lyophilic regions 202a where the active rays hν are incident correspond to the surrounded regions 19(R) of red light-emitting pixels in the wettability changeable layer 202. The liquid repellent regions 202b where the active rays hν are not incident correspond to the surrounded regions 19(G) of green light-emitting pixels, the surrounded regions 19(B) of blue light-emitting pixels, and the partition 20. Hence, the array pattern of the lyophilic regions 202a when viewed from the upper side is the same as the array pattern of the surrounded regions 19(R) when viewed from the upper side.

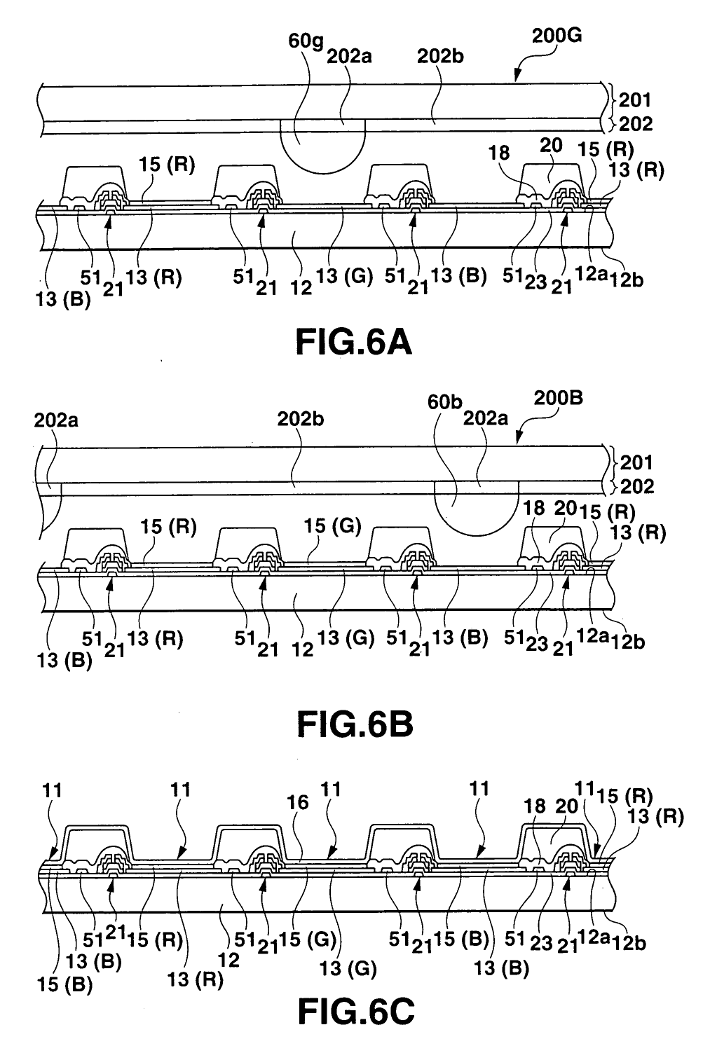

A green plate 200G (FIG. 6A) and blue plate 200B (FIG. 6B) are also made by partially irradiating masters with the active rays hν, like the red plate 200R. For the green plate 200G, the active rays hν are sent onto the wettability changeable layer 202 only in regions corresponding to the green surrounded regions 19(G) by using a photomask substrate. For the blue plate 200B, the active rays hν are sent onto the wettability changeable layer 202 only in regions corresponding to the blue surrounded regions 19(B) by using a photomask substrate. Hence, in the green plate 200G, the array pattern of the lyophilic regions 202a when viewed from the upper side is the same as the array pattern of the surrounded regions 19(G) when viewed from the upper side. In the blue plate 200B, the array pattern of the lyophilic regions 202a when viewed from the upper side is the same as the array pattern of the surrounded regions 19(B) when viewed from the upper side.

The second plate making method will be described.

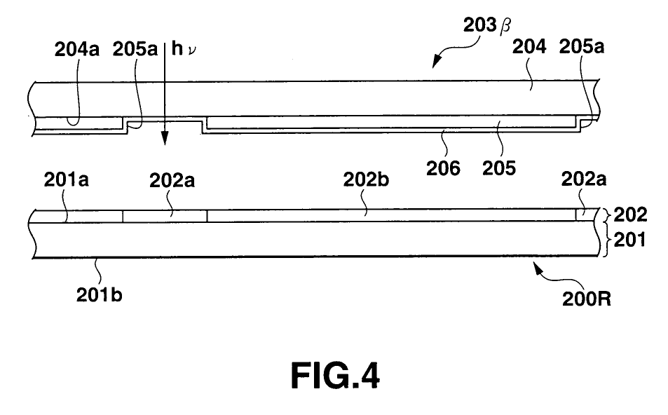

In the second plate making method, the wettability changeable layer 202 need not contain a photocatalyst. However, as shown in FIG. 4, a photomask substrate 203 βis used in place of the photomask substrate 203α used in the first plate making method. The photomask substrate 203β has a transparent substrate 204 and mask 205, like the photomask substrate 203α. In addition, a photocatalytic film 206 that covers the entire mask 205 is formed on a side of the entire surface 204a of the transparent substrate 204. Examples of the photocatalytic material of the photocatalytic film 206 are metal oxides such as titanium oxide (TiO₂), zinc oxide (ZnO), tin oxide (SnO₂), strontium titanate (SrTiO₃), tungsten oxide (WO₃), bismuth oxide (Bi₂O₃), and iron oxide (Fe₂O₃). The binder of the photocatalytic film 206 is not particularly limited as long as it has a resistance against the active rays hν. The photocatalytic film 206 may be formed only on a part of the surface 204a of the transparent substrate 204, which is exposed in the opening portions 205a of the mask 205.

The photomask substrate 203β is made to oppose the wettability changeable layer 202. The opening portions 205a are partially irradiated with the active rays hν from the upper side of the photomask substrate 203β. The photocatalytic film 206 is excited by the active rays hν to generate active oxygen species (·OH). The active oxygen species change the liquid repellency of the opposing lyophilic region 202a to the lyophilic effect. Hence, the plate 200R having a pattern based on the difference between the lyophilic effect and the liquid repellency is completed. The mask 205 shields the active rays hν. The function of the photocatalyst is as follows. When the active rays hν become incident on the photocatalytic film 206, the active oxygen species are generated. The active oxygen species diffuse the gas phase between the photomask substrate 203β and the wettability changeable layer 202. Active oxygen that has arrived at the wettability changeable layer 202 desorbs the functional group that exhibits the liquid repellency in the wettability changeable layer 202 and substitutes the functional group with ones that exhibits a lyophilic effect.

The second plate making method can also be applied to make the green plate 200G and blue plate 200B. The second plate making method is the same as the first plate making method except that the photocatalytic film 206 is formed on the photomask substrate 203β. Even in the second plate making method, the wettability changeable layer 202 can also contain a photocatalyst, as in the first plate making method.

“(i) Driving Substrate Manufacturing Step”

As shown in FIG. 3C, a film formation step such as PVD or CVD, a mask step such as photolithography, and a thin film shape process step such as etching are appropriately executed to pattern the plurality of scanning lines 52 and gate electrodes 22 arrayed in the row direction. Then, the scanning lines 52 and gate electrodes 22 are covered with the gate insulating film 23 that is formed on the entire surface 12a of the transparent substrate 12. Next, the semiconductor film 24, and impurity-doped semiconductor films 25 and 26 are formed and patterned to pattern the anode 13 on the surface 12a of the transparent substrate 12 in correspondence with each sub pixel. The plurality of signal lines 51 are patterned to be arrayed in the column direction that is perpendicular to the row direction. In addition, the drain electrodes 27 and source electrodes 28 are patterned. The source electrodes 28 of the transistors 21 are patterned to be connected to the anodes 13.

After formation of the anodes 13 and transistors 21, a film formation step such as PVD or CVD, a mask step such as photolithography, and a thin film shape process step such as etching are executed to form the mesh-shaped protective insulating film 18 made of silicon nitride or silicon oxide so as to surround each anode 13. A photosensitive resin film made of a photosensitive resin such as polyimide is formed on one surface of the transparent substrate 12. The photosensitive resin film is partially exposed. Then, a removing liquid is applied to the photosensitive resin film to process the shape of the photosensitive resin film into a mesh pattern on the protective insulating film 18. Accordingly, the mesh-shaped partition 20 made of the photosensitive resin is formed. The surrounded regions 19 surrounded by the protective insulating film 18 and partition 20 are formed. In each surrounded region 19, the anode 13 is exposed (FIG. 3D). In exposing a negative photo-sensitive resin film, a portion that overlaps the protective insulating film 18 is irradiated with light. Conversely, in exposing a positive photosensitive resin film, a region surrounded by the protective insulating film 18 is irradiated with light.

Next, the side of the surface 12a of the transparent substrate 12, i.e., the surfaces of the anodes 13, protective insulating film 18, and partition 20 are cleaned. The cleaning may be done by oxygen plasma cleaning under a pressure lower than the atmospheric pressure or by UV/ozone cleaning. A lyophilic process is executed for the surface of the anode 13 in each surrounded region 19, and a liquid repellent process is executed for the surface of the partition 20, as needed. This will be described in detail in the section “Lyophilic Process and Liquid Repellent Process”. The structure having the anodes 13, transistors 21, protective insulating film 18, and partition 20 formed on the surface 12a of the transparent substrate 12 will be referred to as a driving substrate.

“(ii) Print Step”

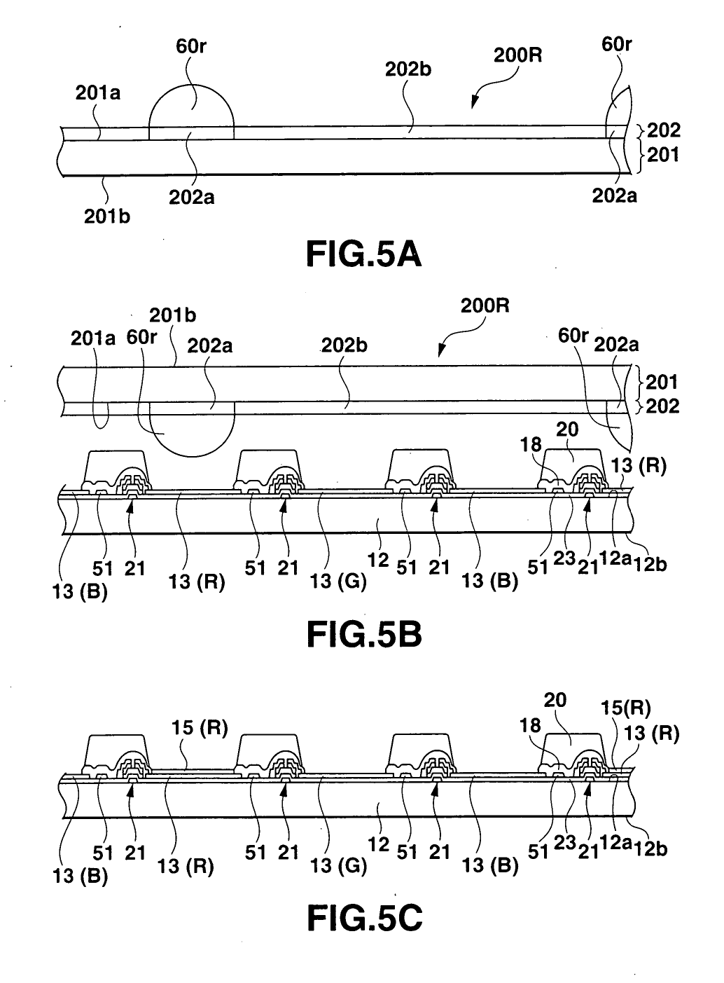

As shown in FIG. 5A, a red organic compound containing liquid 60r is applied on the wettability changeable layer 202 of the red plate 200R. Examples of the applying method are dip coating, die coating, roll coating, and spin coating. In the wettability changeable layer 202, the lyophilic region 202a irradiated with the active rays hν has a lyophilic effect. The liquid repellent region 202b that is not irradiated with the active rays hν has liquid repellency. Hence, a droplet of the organic compound containing liquid 60r sticks to only the lyophilic region 202a irradiated with the active rays hν. At this time, the red plate 200R may be oscillated. Even if a small amount of the organic compound containing liquid 60r remains in the liquid repellent region 202b, the remaining organic compound containing liquid 60r can be removed from the red plate 200R by the surface tension of the organic compound containing liquid 60r. The red plate 200R may be tilted. In this case, the organic compound containing liquid 60r on the liquid repellent region 202b flows down due to its weight while the organic compound containing liquid 60r in the lyophilic region 202a remains. Alternatively, the red plate 200R may be oscillated while being tilted. In this case, the unnecessary organic compound containing liquid 60r on the liquid repellent region 202b can be removed to the outside.

As shown in FIG. 5B, a plate 200 is made to oppose the surface 12a of the transparent substrate 12 on which the transistors 21, anodes 13, and partition 20 are formed. The transparent substrate 12 and red plate 200R are aligned such that the red anodes 13(R) oppose the lyophilic regions 202a with the organic compound containing liquid. When at least one of an arm (not shown) which holds the red plate 200R and a stage (not shown) on which the transparent substrate 12 is placed is appropriately moved, the organic compound containing liquids 60r that are projecting from the surface of the red plate 200R respectively come into contact with the anodes 13(R). The organic compound containing liquid 60r sticking to each lyophilic region 202a is transferred to a corresponding one of red anodes 13(R). If the anode 13 is made of ITO, the metal oxide has a rough surface and wets well with the organic compound containing liquid 60r. With this process, the EL layer 15(R) that emits red light is formed on the anode 13(R) corresponding to a pixel that emits red light in each surrounded region 19(R) (FIG. 5C). Even when a small misalignment occurs, and the organic compound containing liquid 60r comes into contact with the side wall of the partition 20, the organic compound containing liquid flows from the side wall of the partition 20 onto the red anode 13(R). Hence, the variation in thickness of the formed red EL layer 15(R) is not so large as to affect display. Since the surrounded regions 19(R) are separated by the partition 20, the organic compound containing liquid 60r transferred to the surrounded region 19(R) does not leak to the adjacent surrounded region 19 in which an organic compound containing liquid of a different color should be transferred.

As in the red plate, droplets 60g of an organic compound containing liquid containing an organic compound that emits green light are respectively brought into contact with the anodes 13(G) by using the green plate 200G, thereby transferring the organic compound containing liquid to the anodes 13(G). In this way, the green EL layer 15(G) is formed on the anode 13(G) in each surrounded region 19(G) (FIG. 6A). Next, as in the red plate, droplets 60b of an organic compound containing liquid containing an organic compound that emits blue light are correspondingly brought into contact with the anodes 13(G) by using the blue plate 200B, thereby transferring the organic compound containing liquid to the anode 13(B). In this way, the blue EL layer 15(B) is formed on the anode 13(B) in each surrounded region 19(B) (FIG. 6B). The red EL layer 15(R), green EL layer 15(G), and blue EL layer 15(B) need not always be formed in this order. In addition, the red EL layer 15(R), green EL layer 15(G), and blue EL layer 15(B) need not always be arrayed in this order from the left side.

“(iii) Electrode Formation Step”

By a film formation method such as PVD or CVD using deposition or sputtering, the cathode 16 is formed on the entire surface to cover the EL layers 15 (FIG. 6C). After formation of the cathode 16, the organic EL elements 11 are sealed by a sealing medium.

In the organic EL display panel 10 manufactured in the above way, a pixel circuit supplies a current to the organic EL element 11 in accordance with a signal input through the signal line 51 and scanning line 52. In the organic EL element 11, holes are injected from the anode 13 to the EL layer 15 while electrons are injected from the cathode 16 to the EL layer 15 so that a current flows. When the holes and electrons are transported and recombined in the EL layer 15, the EL layer 15 emits light. Since the anode 13 and substrate 12 are transparent, the light emitted by the EL layer 15 exits from a lower surface 12b of the transparent substrate 12. The lower surface 12b serves as a display surface.

As described above, in this embodiment, the plates 200R, 200G, and 200B are made for the respective colors. The EL layers 15 are formed for each color by using a corresponding plate. Hence, the red EL layers 15(R), green EL layers 15(G), or blue EL layers 15(B) can be formed simultaneously. That is, when transfer is executed only three times in (ii) print step, all the EL layers 15 on the transparent substrate 12 can be formed. For this reason, the organic EL display panel 10 can be manufactured in a short time.

Instead of forming the EL layers by using nozzles as in the inkjet method, the EL layers 15 are patterned by transfer using the plates 200R, 200G, and 200B. The larger number of pixels on which EL layers should be formed becomes, the higher the film forming efficiency becomes. In addition, no clogging occurs, unlike the inkjet method. Hence, the EL layers 15 are prevented from having nonuniform thicknesses. Furthermore, the EL layers 15 can be precisely arrayed and formed, as compared to the inkjet method.

“Lyophilic Process and Liquid Repellent Process”

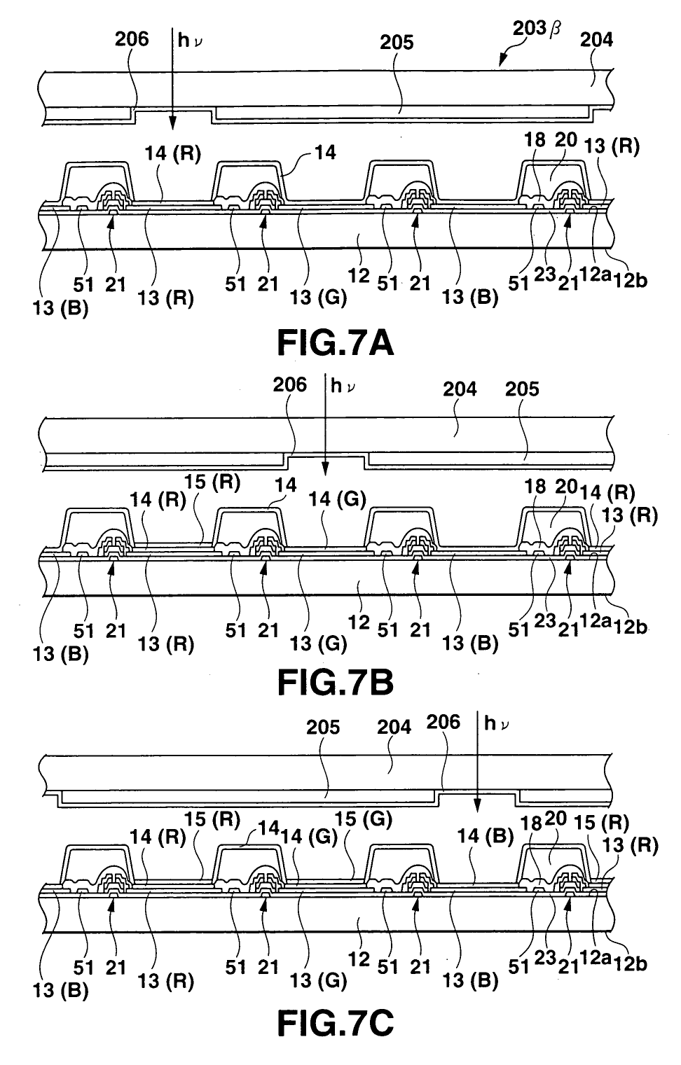

Before (ii) print step, as shown in FIG. 7A, after the side of the surface 12a of the transparent substrate 12 is cleaned by pure water and dried, a second wettability changeable layer 14 that covers the anodes 13 and the entire partition 20 may be formed on a side of the surface 12a of the transparent substrate 12.

The second wettability changeable layer 14 is the same as the wettability changeable layer 202 of the master member as the base of the plate 200 but need not always contain any photocatalyst. When the second wettability changeable layer 14 contains no photocatalyst, corrosion of the anode 13 can be suppressed. In addition, any decrease in hole injection effect from the anode 13 to the EL layer 15 can be suppressed. The second wettability changeable layer 14 can be formed in accordance with the same procedures as those for the wettability changeable layer 202. If no photocatalyst is dispersed in the coating liquid to be changed to the second wettability changeable layer 14, the resultant second wettability changeable layer 14 contains no photocatalyst.

Before (ii) print step, the entire second wettability changeable layer 14 has liquid repellency. The second wettability changeable layer 14 is a liquid repellent layer that repels the organic compound containing liquid. In (ii) print step, before the EL layers 15(R), 15(G), and 15(B) of the respective colors are formed by using the plates, the second wettability changeable layer 14 is irradiated with the active rays hν in regions that overlap the anodes 13(R), 13(G), and 13(B) of the respective colors.

More specifically, as shown in FIG. 7A, before the EL layers 15(R) are formed by using the red plate 200R, only regions that overlap the surrounded regions 19(R) corresponding to pixels that emit red light are irradiated with the active rays hν by using, e.g., the photomask substrate 203α or photomask substrate 203β (in FIG. 7A, the photomask substrate 203β prepared by forming the photocatalytic film 206 on the lower surface of the transparent substrate 204) used in making the red plate 200R. With this process, the second wettability changeable layer 14 changes to the lyophilic layers 14(R) having a lyophilic effect in the regions that overlap the red anodes 13 (R).

Next, as described above in (ii) print step, by using the red plate 200R, a solution containing an EL material that emits red light is transferred and applied onto the lyophilic layers 14(R) formed on the surfaces of the red anodes 13(R). Before the organic compound containing liquid is transferred to the surrounded regions 19(R), the second wettability changeable layer 14 is changed to the lyophilic layers 14(R) having a lyophilic effect only in the surrounded regions 19(R). Hence, the lyophilic layer wets well with the solution containing the EL material that emits red light. The second wettability changeable layer 14 having liquid repellency is formed on the surfaces of the partition 20 and the surrounded regions 19(G) and 19(B) of the remaining colors. The second wettability changeable layer 14 repels the solution containing the EL material that emits red light. For this reason, the solution containing the EL material that emits red light collects only in the red surrounded regions 19(R). When the solvent in the solution dries, the EL layers 15(R) are formed. The EL material that emits red light may be a polymer in the solution. Alternatively, a monomer or oligomer that causes polymerization after the solution may be used.

Next, only the green surrounded regions 19(G) of the second wettability changeable layer 14 are irradiated with the active rays hν by using the photomask substrate 203α or photomask substrate 203β used in making the green plate. With this process, the second wettability changeable layer 14 changes to the lyophilic layers 14(G) in the surrounded regions 19(G) (FIG. 7B). After that, as described above in (ii) print step, by using the green plate 200G, a solution containing an EL material that emits green light is transferred and applied onto the lyophilic layers 14(G) formed on the surfaces of the green anodes 13(G). The surfaces of the surrounded regions 19(G) have the lyophilic layers 14(G) and therefore wets well with the solution. However, the second wettability changeable layer 14 remains liquid repellent on the surfaces of the partition 20 and the surrounded regions 19(B) of the remaining color. The second wettability changeable layer 14 repels the solution containing the EL material that emits green light. For this reason, the solution containing the EL material that emits green light collects only in the green surrounded regions 19(G). When the solvent in the solution dries, the EL layers 15(G) are formed. The EL material that emits green light may be a polymer in the solution. Alternatively, a monomer or oligomer that causes polymerization after the solution may be used.

Next, only the blue surrounded regions 19(B) of the second wettability changeable layer 14 are irradiated with the active rays hν by using the photomask substrate 203α or photomask substrate 203β used in making the blue plate. With this process, the second wettability changeable layer 14 changes to the lyophilic layers 14(B) in the surrounded regions 19(B) (FIG. 7C). After that, as described above in (ii) print step, by using the blue plate, a solution containing an EL material that emits blue light is transferred and applied onto the lyophilic layers 14(B) formed on the surfaces of the blue anodes 13(B) corresponding to the EL layers 15(B). The surfaces of the surrounded regions 19(B) have the lyophilic layers 14(B) and therefore wets well with the solution. However, the second wettability changeable layer 14 remains liquid repellent on the surface of the partition 20. The second wettability changeable layer 14 repels the solution containing the EL material that emits blue light. For this reason, the solution containing the EL material that emits blue light collects only in the blue surrounded regions 19(B). When the solvent in the solution dries, the EL layers 15(B) are formed. The EL material that emits blue light may be a polymer in the solution. Alternatively, a monomer or oligomer that causes polymerization after the solution may be used.

FIGS. 7A to 7C show the photomask substrate 203β on which the photocatalytic film 206 is formed. When the second wettability changeable layer 14 contains a photocatalyst, the photomask substrate 203α may be used.

For example, when the second wettability changeable layer 14 is formed by hydrolyzing and condensing a silazane compound having a fluoroalkyl group represented by general formula (5), the main chain of silicon and oxygen is formed along the surfaces of the anodes 13, protective insulating film 18, and partition 20. The second wettability changeable layer 14 is very thin. Additionally, in the lyophilic layers 14(R), 14(G), and 14(B), the fluoroalkyl group arranged in the direction of thickness of the second wettability changeable layer 14 is substituted with a hydroxyl group. For this reason, the lyophilic layers 14(R), 14(G), and 14(B) in the surrounded regions 19 become thinner, i.e., the thickness falls between 0.0 nm (exclusive) and 1.0 nm (inclusive). That is, the lyophilic layers 14(R), 14(G), and 14(B) are thinner than a portion (liquid repellent portion) that is not irradiated with light. Hence, even when any one of the lyophilic layers 14(R), 14(G), and 14(B) is inserted between the anode 13 and the EL layer 15, the insulating properties of the lyophilic layers 14(R), 14(G), and 14(B) can be neglected. For this reason, hole injection from the anode 13 to the EL layer 15 is not impeded.

Instead of forming the second wettability changeable layer 14, the surfaces of the anodes 13 may be imparted with a lyophilic effect, and the surface of the partition 20 may be imparted with liquid repellency by the following method. Before (ii) print step, the partition 20 is irradiated with a fluoride plasma such as CF₄ plasma. At this time, a radical species of fluorine reacts in the surface layer of the partition 20 and forms a fluoride (mainly a compound of fluorine and carbon) in the surface layer of the partition 20. Accordingly, the surface of the partition 20 obtains liquid repellency. Next, the anodes 13 are irradiated with an oxygen plasma. The surface layers of the anodes 13 are ashed so that the fluoride layers in the surface layers of the anodes 13 are removed. Accordingly, the anodes 13 obtain a lyophilic effect. After that, the above-described (ii) print step is executed.

[Second Embodiment]

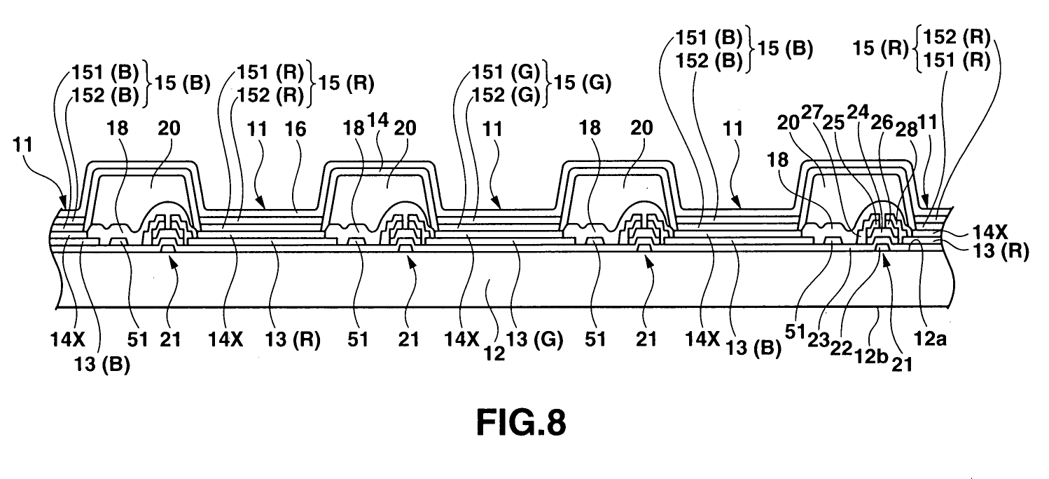

In this embodiment, an EL display panel 105 having EL layers 15 each constructed by a plurality of charge transport layers, as shown in the sectional view of FIG. 8, will be described. In the organic EL display panel 105, each EL layer 15 has a multilayered structure in which a hole transport layer 151 and a light-emitting layer 152 of narrow sense are stacked in this order sequentially from an anode 13. The remaining constituent elements of the organic EL display panel 105 are the same as those of the organic EL display panel 10 of the first embodiment. The same reference numerals as in the organic EL display panel 10 denote the same constituent elements in the organic EL display panel 105, and a detailed description thereof will be omitted. Throughout the drawing, (R) is added to the light-emitting layer 152 of narrow sense, which emits red light. (G) is added to the light-emitting layer 152 of narrow sense, which emits green light. (B) is added to the light-emitting layer 152 of narrow sense, which emits blue light. (R), (G), or (B) is also added to the hole transport layer 151 corresponding to each color.

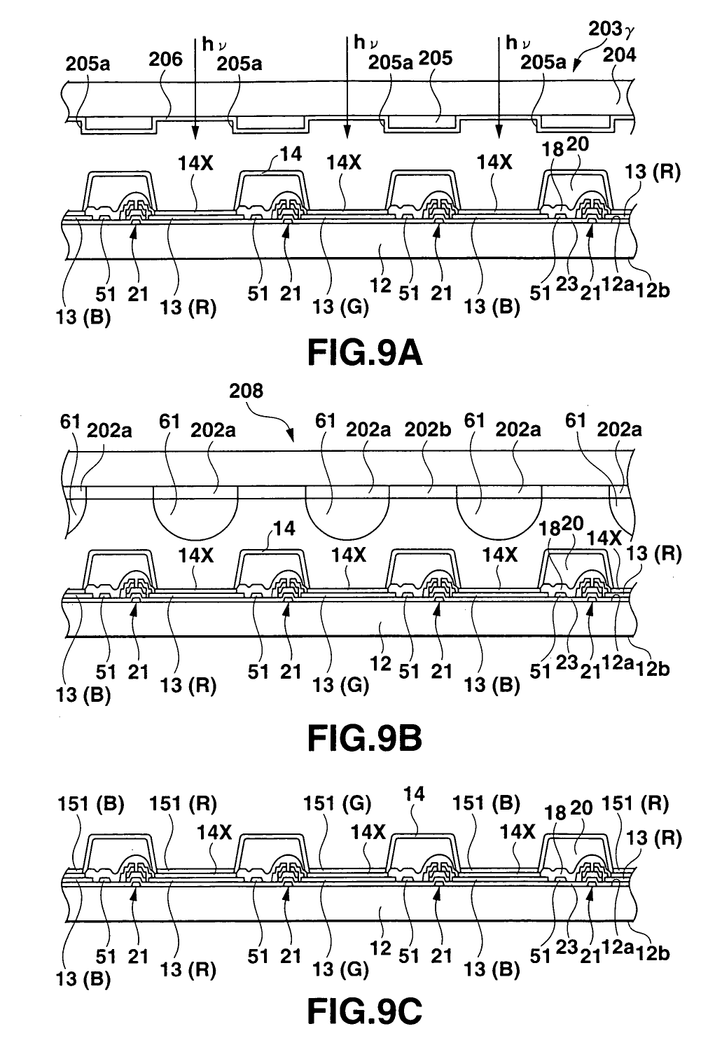

A method of manufacturing the EL display panel 105 will be described next with reference to FIGS. 9A to 11C. FIGS. 9A to 11C are sectional views showing the method of manufacturing the EL display panel 105 according to the second embodiment.

First, as in the first embodiment, (i) driving substrate manufacturing step is executed to manufacture a driving substrate. The surface side of the driving substrate is cleaned by pure water. Then, a second wettability changeable layer 14 that covers the anodes 13 and an entire partition 20 is formed on an entire surface 12a of a transparent substrate 12.

The second wettability changeable layer 14 is the same as a wettability changeable layer 202 but need not always contain any photocatalyst. When the second wettability changeable layer 14 contains no photocatalyst, corrosion of the anode 13 can be suppressed. In addition, any decrease in hole injection effect from the anode 13 to the EL layer 15 can be suppressed. The second wettability changeable layer 14 can be formed in accordance with the same procedures as those for the wettability changeable layer 202. If no photocatalyst is dispersed in the coating liquid, the resultant second wettability changeable layer 14 contains no photocatalyst.

Next, as shown in FIG. 9A, portions of the second wettability changeable layer 14 where a red hole transport layer 151(R), green hole transport layer 151(G), and blue hole transport layer 151(B) (to be described later) should be formed are exposed by using a photomask substrate 203γ. The photomask substrate 203α has a flat transparent substrate 204 that passes active rays hν. A mask 205 that does not pass the active rays hν and has a mesh pattern, like the partition 20, is formed on a surface 204a of the transparent substrate 204. Since the mask 205 has a mesh pattern, opening portions 205a arrayed in a matrix are formed in the mask 205. That is, the array pattern of the opening portions 205a when viewed from the upper side corresponds to the array pattern of surrounded regions 19 corresponding to all pixels, i.e., R, G, and B pixels. A photocatalytic film 206 is formed on the lower surface of the transparent substrate 204 to cover the mask 205.

When the photomask substrate 203y is used, the transparent substrate 204 is placed on the transparent substrate 12 such that the opening portions 205a oppose the surrounded regions 19(R), 19(G), and 19(B). The transparent substrate 204 is irradiated with the active rays hν from the upper side. By the photocatalytic function of the photocatalytic film 206, a functional group having liquid repellency in the second wettability changeable layer 14 is desorbed and substituted with a functional group having a lyophilic effect only on the anodes 13(R), 13(G), and 13(B) (i.e., only on the portions irradiated with the light) so that lyophilic layers 14X are formed. At this time, the second wettability changeable layer 14 that covers the surface of the partition 20 is shielded from the active rays hν by the mask 205. Hence, the second wettability changeable layer 14 does not change to the lyophilic layer 14X.

As shown in FIG. 9B, the wettability changeable layer 202 of a plate 208, which has a pattern with lyophilic regions 202a and liquid repellent region 202b, is made to oppose the transparent substrate 12. The lyophilic regions 202a of the plate 208 are arrayed in a matrix. The liquid repellent region 202b has a mesh pattern. That is, the array pattern of the lyophilic regions 202a when viewed from the upper side corresponds to that of the surrounded regions 19 corresponding to the pixels of all colors. The array pattern is almost the same as that of the lyophilic layers 14X. Droplets 61 of a solution containing at least a hole transport material stick to the surfaces of the respective lyophilic regions 202a in equal amounts. The droplet 61 may be a solution containing an organic material such as a mixture of poly-(3, 4) ethylene dioxythiophene and polystyrene sulfonate. A solution in which a hole transport inorganic material is dispersed may be used. Alternatively, a mixture of the above solutions may be used. When a solution containing a hole transport material is applied on the entire surface of the plate 208, the droplets 61 can have a predetermined pattern due to the lyophilic and liquid repellent effects of the lyophilic regions 202a and liquid repellent region 202b which are formed on the surface.

The above-described plate 208 is placed closer to the transparent substrate 12. As shown in FIG. 9C, the droplets 61 come into contact with the lyophilic layers 14X of the transparent substrate 12 and are thus transferred onto the lyophilic layers 14X. When the droplets dry, the hole transport layers 151(R), 151(G), and 151(B) are formed. At this time, even when the droplet 61 comes into contact with the second wettability changeable layer 14 that covers the side wall surface of the partition 20, the droplet 61 is repelled and inevitably flows onto the lyophilic layer 14X. Since the droplet 61 spreads on the lyophilic layer 14X in a uniform thickness, a hole transport layer 151 having a uniform thickness can be formed. At this time, all the hole transport layers 151(R), 151(G), and 151(B) are made of the same material.

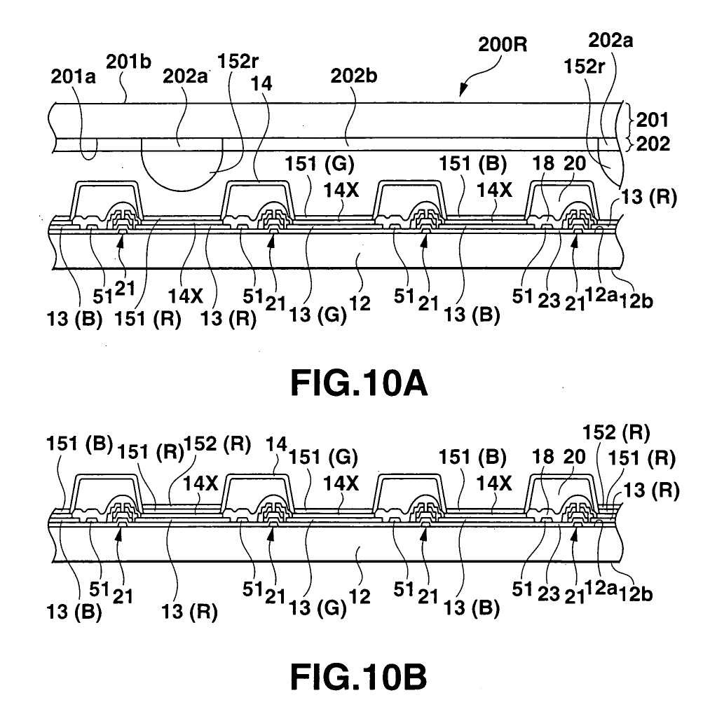

As shown in FIG. 10A, light-emitting layers 152(R) of narrow sense are formed by using a red plate 200R. More specifically, a predetermined amount of a red organic compound containing liquid 152r is applied on each lyophilic region 202a of the red plate 200R as a droplet. The red plate 200R is aligned by moving at least one of the red plate 200R and the transparent substrate 12 such that the red organic compound containing liquid 152r opposes the hole transport layer 151(R) on each anode 13(R) of the transparent substrate 12. The organic compound containing liquid 152r is a liquid containing an organic compound that forms the light-emitting layer 152(R) of narrow sense, or its precursor. The liquid may be a solution prepared by dissolving, as a solute, an organic compound that forms the light-emitting layer 152(R) of narrow sense, or its precursor in a solvent. Alternatively, the liquid may be a dispersion prepared by dispersing an organic compound that forms the light-emitting layer 152(R) of narrow sense, or its precursor in a liquid.

At least one of the red plate 200R and transparent substrate 12 is moved to bring the red organic compound containing liquid 152r on the red plate 200R into contact with the hole transport layer 151(R) on each anode 13(R) of the transparent substrate 12. The red organic compound containing liquid 152r on the red plate 200R is transferred onto the hole transport layer 151(R) on each anode 13(R). After drying, light-emitting layers 152(R) of narrow sense are formed, as shown in FIG. 10B.

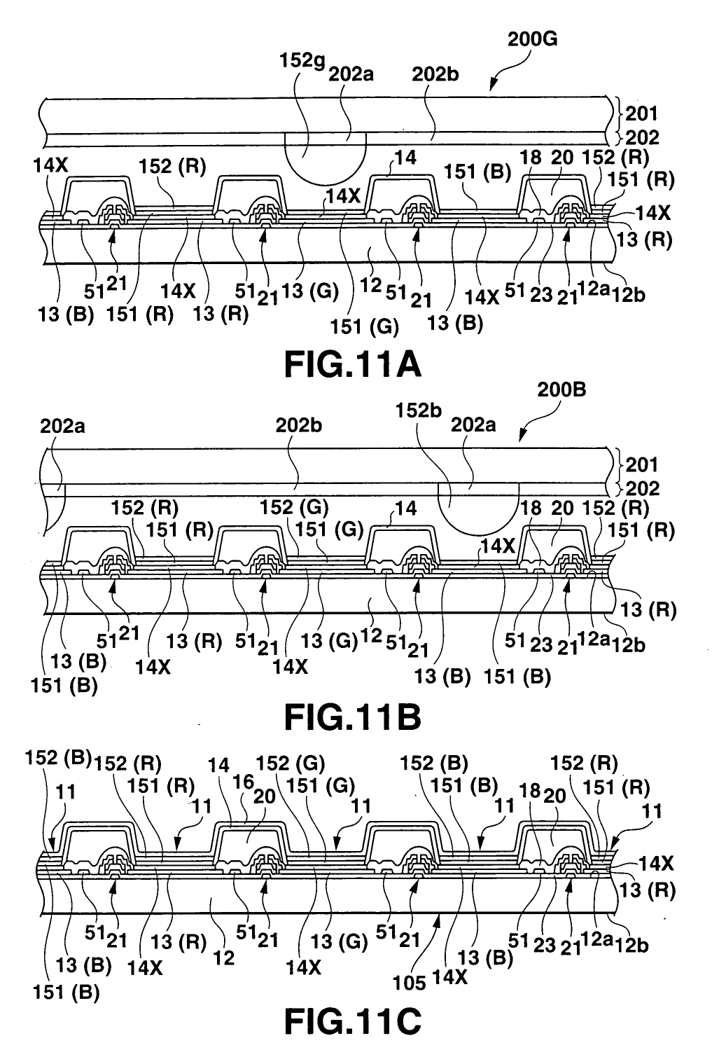

As shown in FIG. 11A, light-emitting layers 152(G) of narrow sense are formed by using a green plate 200G. More specifically, a predetermined amount of a green organic compound containing liquid 152g is applied on each lyophilic region 202a of the green plate 200G as a droplet. The green plate 200G is aligned by moving at least one of the green plate 200G and the transparent substrate 12 such that the green organic compound containing liquid 152g opposes the hole transport layer 151(G) on each anode 13(G) of the transparent substrate 12. The organic compound containing liquid 152g is a liquid containing an organic compound that forms the light-emitting layer 152(G) of narrow sense, or its precursor. The liquid may be a solution prepared by dissolving, as a solute, an organic compound that forms the light-emitting layer 152(G) of narrow sense, or its precursor in a solvent. Alternatively, the liquid may be a dispersion prepared by dispersing an organic compound that forms the light-emitting layer 152(G) of narrow sense, or its precursor in a liquid.

At least one of the green plate 200G and transparent substrate 12 is moved to bring the green organic compound containing liquid 152g on the green plate 200G into contact with the hole transport layer 151(G) on each anode 13(G) of the transparent substrate 12. The green organic compound containing liquid 152g on the green plate 200G is transferred onto the hole transport layer 151(G) on each anode 13(G). After drying, light-emitting layers 152(G) of narrow sense are formed. From the viewpoint of yield, the green organic compound containing liquid 152g is preferably transferred after the red organic compound containing liquid 152r transferred onto the anodes 13(G) dries and changes to the light-emitting layers 152(R) of narrow sense. If priority is placed on mass production, transfer may be executed before drying is ended.

As shown in FIG. 11B, light-emitting layers 152(B) of narrow sense are formed by using a blue plate 200B. More specifically, a predetermined amount of a blue organic compound containing liquid 152b is applied on each lyophilic region 202a of the blue plate 200B as a droplet. The blue plate 200B is aligned by moving at least one of the blue plate 200B and the transparent substrate 12 such that the blue organic compound containing liquid 152b opposes the hole transport layer 151(B) on each anode 13(B) of the transparent substrate 12. The organic compound containing liquid 152b is a liquid containing an organic compound that forms the light-emitting layer 152(B) of narrow sense, or its precursor. The liquid may be a solution prepared by dissolving, as a solute, an organic compound that forms the light-emitting layer 152(B) of narrow sense, or its precursor in a solvent. Alternatively, the liquid may be a dispersion prepared by dispersing an organic compound that forms the light-emitting layer 152(B) of narrow sense, or its precursor in a liquid.

At least one of the blue plate 200B and transparent substrate 12 is moved to bring the blue organic compound containing liquid 152b on the blue plate 200B into contact with the hole transport layer 151(B) on each anode 13(B) of the transparent substrate 12. The blue organic compound containing liquid 152b on the blue plate 200B is transferred onto the hole transport layer 151(B) on each anode 13(B). After drying, light-emitting layers 152(B) of narrow sense are formed. From the viewpoint of yield, the blue organic compound containing liquid 152b is preferably transferred after the green organic compound containing liquid 152g transferred onto the anodes 13(G) dries and changes to the light-emitting layers 152(G) of narrow sense. If priority is placed on mass production, transfer may be executed before drying is ended. The red light-emitting layer 152(R), green light-emitting layer 152(G), and blue light-emitting layer 152(B) need not always be formed in this order. In addition, the red light-emitting layer 152(R), green light-emitting layer 152(G), and blue light-emitting layer 152(B) need not always be arrayed in this order.

As shown in FIG. 1C, by a film formation method such as PVD or CVD using deposition or sputtering, a cathode 16 is formed on the entire surface to cover the light-emitting layers 152 of narrow sense. After formation of the cathode 16, the organic EL elements 11 are sealed by a sealing medium (not shown).

In patterning the lyophilic regions 202a on the red plate 200R, green plate 200G, or blue plate 200B, when the wettability changeable layer 202 contains a photocatalyst, the lyophilic regions 202a may be patterned by using a photomask substrate 203α. When the wettability changeable layer 202 contains no photocatalyst, patterning may be executed by using the photomask substrate 203α. In patterning the lyophilic regions 202a on the plate 208, when the wettability changeable layer 202 contains a photocatalyst, the lyophilic regions 202a on the plate 208 may be patterned by using a photomask substrate obtained by removing the photocatalytic film 206 from the photomask substrate 203γ. When the wettability changeable layer 202 contains no photocatalyst, patterning is executed by using the photomask substrate 203γ.

If the application pattern accuracy of the droplets 61 and its transfer pattern accuracy to the transparent substrate 12 by the plate 208 are high, the second wettability changeable layer 14 and lyophilic layers 14X need not always be formed on the transparent substrate 12.

[Third Embodiment]

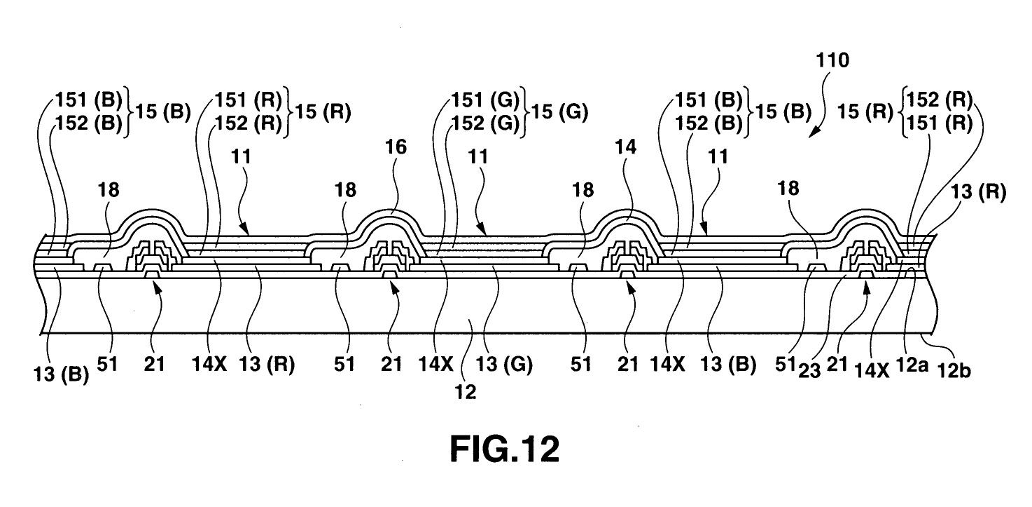

In this embodiment, an EL display panel 110 having no partition, as shown in the sectional view of FIG. 12, will be described. The remaining constituent elements of the organic EL display panel 110 are the same as those of the organic EL display panel 105 of the second embodiment. The same reference numerals as in the organic EL display panel 105 denote the same constituent elements in the organic EL display panel 110, and a detailed description thereof will be omitted.

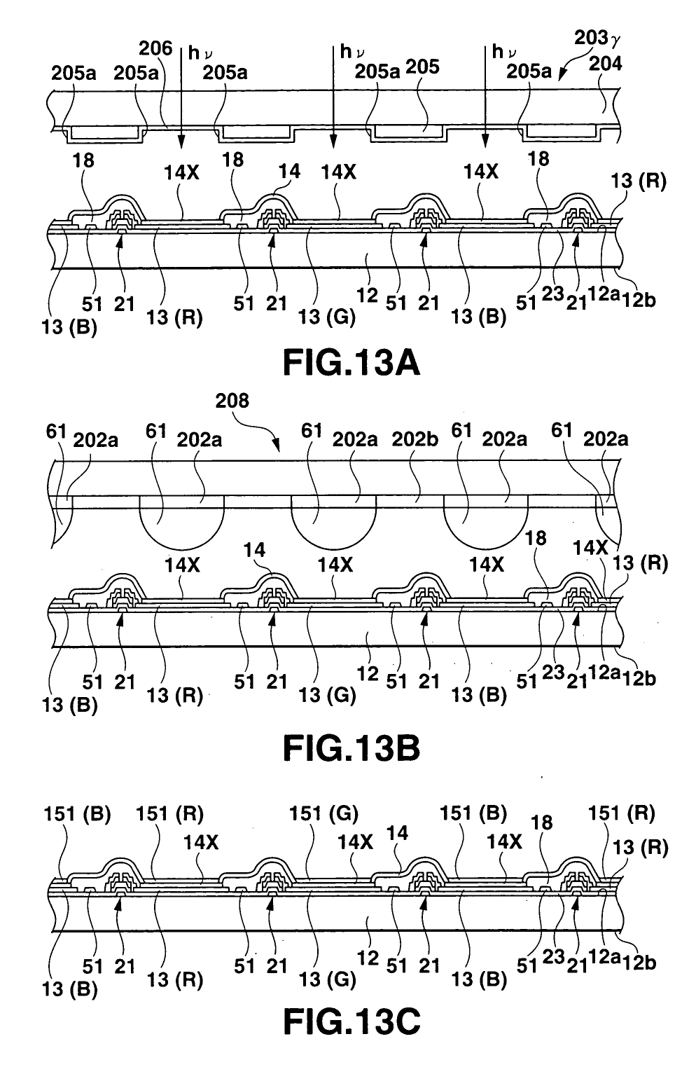

A method of manufacturing the organic display panel 110 will be described next with reference to FIGS. 13A to 15C. FIGS. 13A to 15C are sectional views showing the method of manufacturing the EL display panel 110 according to the third embodiment.

As shown in FIG. 3C, as in the first embodiment, signal lines 51 and scanning lines 52 are patterned on a transparent substrate 12. An anode 13 and transistors 21 are patterned for each pixel on a surface 12a of the transparent substrate 12. After that, a protective insulating film 18 is formed to cover the transistors 21 and interconnections such as the signal lines 51. In the first embodiment, the partition 20 is patterned. In the third embodiment, no partition is formed. Next, as in the first embodiment, a second wettability changeable layer 14 having liquid repellency is formed on the entire surface on the side of the surface 12a of the transparent substrate 12 to cover the anodes 13 and protective insulating film 18. The second wettability changeable layer 14 preferably contains no photocatalyst.

Next, as shown in FIG. 13A, the second wettability changeable layer 14 is partially exposed by the photocatalyst by using a photomask substrate 203γ, as in the second embodiment. More specifically, a transparent substrate 204 is placed on the transparent substrate 12 such that the array pattern of opening portions 205a opposes that of surrounded regions 19. The transparent substrate 204 is irradiated with active rays hν from the upper side. By the photocatalytic function of the photocatalytic film 206, a functional group having liquid repellency in the second wettability changeable layer 14 is desorbed and substituted with a functional group having a lyophilic effect only on the anodes 13(R), 13(G), and 13(B) (i.e., only on the portions irradiated with the light) so that lyophilic layers 14X are formed. At this time, the second wettability changeable layer 14 that covers the surface of the protective insulating film 18 which protects the transistors 21 is shielded from the active rays hν by a mask 205. Hence, the second wettability changeable layer 14 does not change to the lyophilic layer 14X.

As shown in FIG. 13B, as in the second embodiment, a droplet 61 is applied on each lyophilic region 202a of a plate 208. The plate 208 is placed closer to the transparent substrate 12. The droplet 61 is a solution containing at least a hole transport material. The droplet 61 may be a solution containing an organic material such as a mixture of poly-(3, 4) ethylene dioxythiophene and polystyrene sulfonate. A solution in which a hole transport inorganic material is dispersed may be used. Alternatively, a mixture of the above solutions may be used.

Then, as shown in FIG. 13C, the droplet 61 comes into contact with each lyophilic layer 14X on the transparent substrate 12 and is selectively transferred onto the lyophilic layer 14X. After drying, hole transport layers 151 are formed. At this time, even when the droplet 61 comes into contact with the second wettability changeable layer 14 that covers the side wall surface of the partition 20, the droplet 61 is repelled and inevitably flows onto the lyophilic layer 14X. Since the droplet 61 spreads on the lyophilic layer 14X in a uniform thickness, a hole transport layer 151 having a uniform thickness can be formed.

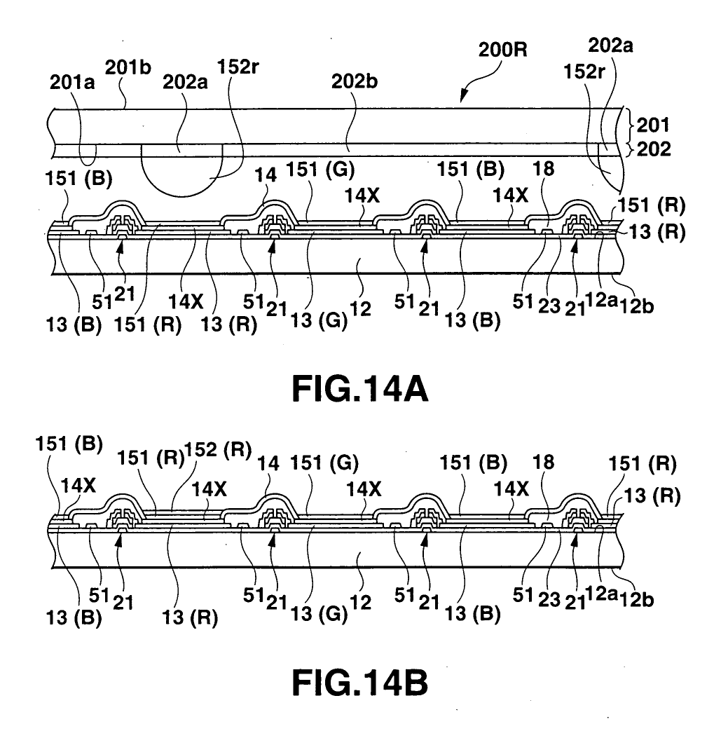

As shown in FIG. 14A, light-emitting layers 152(R) of narrow sense are formed by using a red plate 200R. More specifically, a predetermined amount of a red organic compound containing liquid 152r is applied on each lyophilic region 202a of the red plate 200R. The red plate 200R is aligned by moving at least one of the red plate 200R and the transparent substrate 12 such that the red organic compound containing liquid 152r opposes the hole transport layer 151(R) on each anode 13(R) of the transparent substrate 12.

At least one of the red plate 200R and transparent substrate 12 is moved to bring the red organic compound containing liquid 152r on the red plate 200R into contact with the hole transport layer 151(R) on each anode 13(R) of the transparent substrate 12. The red organic compound containing liquid 152r on the red plate 200R is transferred onto the hole transport layer 151(R) on each anode 13(R). After drying, light-emitting layers 152(R) of narrow sense are formed, as shown in FIG. 14B.

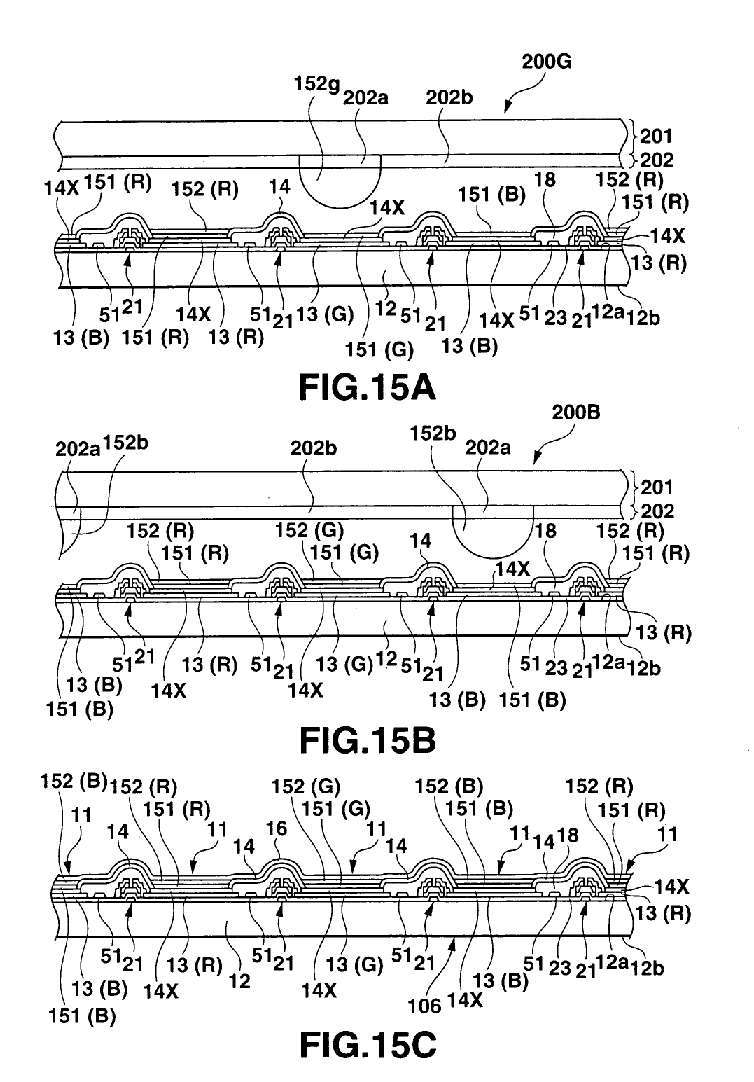

As shown in FIG. 15A, light-emitting layers 152(G) of narrow sense are formed by using a green plate 200G. More specifically, a predetermined amount of a green organic compound containing liquid 152g is applied on each lyophilic region 202a of the green plate 200G. The green plate 200G is aligned by moving at least one of the green plate 200G and the transparent substrate 12 such that the green organic compound containing liquid 152g opposes the hole transport layer 151(G) on each anode 13(G) of the transparent substrate 12.

At least one of the green plate 200G and transparent substrate 12 is moved to bring the green organic compound containing liquid 152g on the green plate 200G into contact with the hole transport layer 151(G) on each anode 13(G) of the transparent substrate 12. The green organic compound containing liquid 152g on the green plate 200G is transferred onto the hole transport layer 151(G) on each anode 13(G). After drying, light-emitting layers 152(G) of narrow sense are formed. From the viewpoint of yield, the green organic compound containing liquid 152g is preferably transferred after the red organic compound containing liquid 152r transferred onto the anodes 13(G) dries and changes to the light-emitting layers 152(R) of narrow sense. If priority is placed on mass production, transfer may be executed before drying is ended.

As shown in FIG. 15B, light-emitting layers 152(B) of narrow sense are formed by using a blue plate 200B. More specifically, a predetermined amount of a blue organic compound containing liquid 152b is applied on each lyophilic region 202a of the blue plate 200B. The blue plate 200B is aligned by moving at least one of the blue plate 200B and the transparent substrate 12 such that the blue organic compound containing liquid 152b opposes the hole transport layer 151(B) on each anode 13(B) of the transparent substrate 12.

At least one of the blue plate 200B and transparent substrate 12 is moved to bring the blue organic compound containing liquid 152b on the blue plate 200B into contact with the hole transport layer 151(B) on each anode 13(B) of the transparent substrate 12. The blue organic compound containing liquid 152b on the blue plate 200B is transferred onto the hole transport layer 151(B) on each anode 13(B). After drying, light-emitting layers 152(B) of narrow sense are formed. From the viewpoint of yield, the blue organic compound containing liquid 152b is preferably transferred after the green organic compound containing liquid 152g transferred onto the anodes 13(G) dries and changes to the light-emitting layers 152(G) of narrow sense. If priority is placed on mass production, transfer may be executed before drying is ended. The red light-emitting layer 152(R), green light-emitting layer 152(G), and blue light-emitting layer 152(B) need not always be formed in this order. In addition, the red light-emitting layer 152(R), green light-emitting layer 152(G), and blue light-emitting layer 152(B) need not always be arrayed in this order.

As shown in FIG. 15C, by a film formation method such as PVD or CVD using deposition or sputtering, a cathode 16 is formed on the entire surface to cover the light-emitting layers 152 of narrow sense. After formation of the cathode 16, the organic EL elements 11 are sealed by a sealing medium (not shown).

If the application pattern accuracy of the droplets 61 and its transfer pattern accuracy to the transparent substrate 12 by the plate 208 are high, the second wettability changeable layer 14 and lyophilic layers 14X need not always be formed on the transparent substrate 12.

In patterning the lyophilic regions 202a on the red plate 200R, green plate 200G, or blue plate 200B, when the wettability changeable layer 202 contains a photocatalyst, a photomask substrate 203α may be used in place of the photomask substrate 203β. Alternatively, both the plate and photomask substrate may contain a photocatalyst.

Even in this embodiment, the red hole transport layers 151(R), green hole transport layers 151(G), or blue hole transport layers 151(B) can be simultaneously formed, as in the second embodiment. In addition, the red light-emitting layers 152(R), green light-emitting layers 152(G), or blue light-emitting layers 152(B) can be simultaneously formed for each color. Hence, the organic EL display panel 110 can be manufactured in a short time. Furthermore, the EL layers 15 are patterned by transfer using the plates 200R, 200G, and 200B. Hence, the EL layers 15 are prevented from having nonuniform thicknesses. Also, the EL layers 15 can be precisely arrayed and formed, as compared to the inkjet method.

In addition, a pattern having lyophilic regions and a liquid repellent region is formed on the second wettability changeable layer 14. For this reason, the EL layer 15 for each sub pixel can be patterned without forming the partition 20, unlike the first embodiment.

The present invention is not limited to the above embodiments, and various changes and modifications can be made within the spirit and scope of the invention.

In the above embodiments, the cathode 16 is common to all the organic EL elements 11. However, a cathode common to the organic EL elements 11 of the same color may be formed. That is, a red cathode common to red pixels, a green cathode common to green pixels, and a blue cathode common to blue pixels may be electrically insulated from each other. A cathode may be formed for each organic EL element 11. When a cathode is formed for each organic EL element 11, an anode common to all the organic EL elements 11 may be formed. In this case, the pixel circuit for each sub pixel is connected to the cathode. The organic EL element 11 may have a cathode, EL layer, and anode sequentially from the transparent substrate 12. In the above embodiments, the present invention is applied to an active matrix organic EL display panel having the transistors 21. The present invention can also be applied to a simple matrix driving display panel.

According to the present invention, optical material layers corresponding to a plurality of pixels can be simultaneously formed. Hence, the productivity can be increased as compared to the inkjet method which applies an optical material for each pixel. The liquid repellent portion of the wettability changeable layer of the pattern repels the optical material containing liquid. Most of the optical material containing liquid collects at a desired pattern portion. Since the amount of the optical material containing liquid can be a minimum necessary amount, the cost can be reduced.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A display apparatus comprising:
a substrate;
a first electrode and a second electrode which are formed on one side of the substrate; and
an optical material layer which is located between the first electrode and the second electrode and formed by bringing a droplet of an optical material containing liquid, that sticks to a predetermined position of a surface of a plate in accordance with a pattern based on a difference in wettability, into contact with the substrate and transferring the droplet to the substrate side.

2. An apparatus according to claim 1, wherein the substrate has a wettability changeable layer formed on the first electrode, the wettability changeable layer having at least one lyophilic portion and at least one liquid repellent portion continued from the lyophilic portion.

3. An apparatus according to claim 2, wherein the first electrode comprises a plurality of first electrode sections, the lyophilic portion is formed on each first electrode section, and the liquid repellent portion is formed on a portion between the plurality of first electrode sections.

4. An apparatus according to claim 2, wherein the liquid repellent portion has a functional group containing fluorine, and the lyophilic portion contains no fluorine.

5. An apparatus according to claim 2, wherein the liquid repellent portion has a functional group containing fluorine, and the lyophilic portion has a structure in which the functional group containing fluorine in the liquid repellent portion is substituted with a functional group containing no fluorine.

6. An apparatus according to claim 2, wherein the lyophilic portion of the wettability changeable layer is thinner than the liquid repellent portion thereof.

7. An apparatus according to claim 2, wherein the lyophilic portion has a thickness between 0.0 nm (exclusive) and 1.0 nm (inclusive).

8. An apparatus according to claim 1, wherein the optical material layer is surrounded by a partition.

9. A method of manufacturing a display apparatus including an optical element having an optical material layer between a first electrode and a second electrode which are formed on a one side of a substrate, comprising:
an aligning step of making the substrate oppose a plate which has a wettability changeable layer and to which a droplet of an optical material containing liquid sticks in accordance with a pattern based on a difference in wettability, and of aligning the substrate and the plate; and
a transfer step of bringing the droplet into contact with the substrate to transfer the droplet to the substrate side, thereby forming the optical material layer.

10. A method according to claim 9, wherein the transfer step is a step of transferring the droplet onto the first electrode.

11. A method according to claim 9, wherein the first electrode comprises a plurality of first electrode sections,
the substrate comprises a wettability changeable layer having a lyophilic portion formed on each first electrode section and a liquid repellent portion formed on a portion between the plurality of first electrode sections, and
the transfer step is transferring the droplet onto the lyophilic portion.

12. A method according to claim 9, wherein
the optical material layer contains a charge transport layer material and a light-emitting layer material, and
the transfer step is transferring at least one of a droplet of an optical material containing liquid containing the charge transport layer material and a droplet of an optical material containing liquid containing the light-emitting layer material.

13. A method according to claim 9, further comprising, as pre-steps of the aligning step,
a step of forming, on the substrate having the first electrode, a second wettability changeable layer whose wettability for an optical material containing liquid can change upon irradiation of active rays, and
an active ray irradiation step of irradiating the second wettability changeable layer on the first electrode with the active rays.

14. A method according to claim 9, wherein
the plate includes
a first plate to which a first droplet of an optical material containing liquid containing a first light-emitting layer material that emits light of a first color sticks in a predetermined pattern, and
a second plate to which a second droplet of an optical material containing liquid containing a second light-emitting layer material that emits light of a color different from the first color sticks in a pattern different from that of the first droplet, and
the transfer step includes a step of transferring the first droplet to the substrate side by using the first plate and then transferring the second droplet to the substrate side by using the second plate.

15. A method according to claim 13, wherein
the plate includes
a first plate to which a first droplet of an optical material containing liquid containing a first light-emitting layer material that emits light of a first color sticks in a predetermined pattern, and
a second plate to which a second droplet of an optical material containing liquid containing a second light-emitting layer material that emits light of a color different from the first color sticks in a pattern different from that of the first droplet, and
the transfer step includes a step of irradiating the second wettability changeable layer at a position corresponding to the pattern of the first droplet sticking to the first plate with the active rays, transferring the first droplet to the substrate side by using the first plate, irradiating the second wettability changeable layer at a position corresponding to the pattern of the second droplet sticking to the second plate with the active rays, and then transferring the second droplet to the substrate side by using the second plate.

16. A method according to claim 9, wherein the wettability changeable layer has a compound in which a fluoroalkyl group is bonded to a main chain made of silicon and oxygen.

17. A method according to claim 9, wherein the wettability changeable layer has a condensate obtained by hydrolyzing and condensing a silazane compound having a fluoroalkyl group.

18. A method according to claim 9, wherein the wettability changeable layer has a photocatalyst.

19. A method according to claim 9, wherein
one of the first and second electrodes is formed on the substrate for each sub pixel, and a partition that surrounds one of the electrodes is formed on the substrate, and
in the transfer step, a droplet of an optical material containing liquid is transferred to a region surrounded by the partition.

20. A display apparatus manufacturing apparatus for manufacturing a display apparatus including an optical element having an optical material layer between a first electrode and a second electrode which are formed on one side of a substrate, comprising:
moving means, having a plate having a wettability changeable layer with a pattern based on a difference in wettability to an optical material containing liquid, for bringing a droplet sticking to the wettability changeable layer into contact with the substrate.
